(19) United States
(12) Patent Application Publication
(10) Pub. No.: US 2024/0036824 A1
(43) Pub. Date: Feb. 1, 2024

(54) METHODS AND SYSTEMS EMPLOYING ENHANCED BLOCK FLOATING POINT NUMBERS

(71) Applicant: Arm Limited, Cambridge (GB)

(72) Inventors: Neil Burgess, Cardiff (GB); Sangwon Ha, Cambridge (GB); Partha Prasun Maji, Cambridge (GB)

(73) Assignee: Arm Limited, Cambridge (GB)

(21) Appl. No.: 18/213,469

(22) Filed: Jun. 23, 2023

(30) Foreign Application Priority Data
Aug. 1, 2022 (GB) 2211212.2

(51) Int. Cl. G06F 7/499

(52) U.S. Cl. CPC G06F 7/49947; G06F 7/49915

(57) ABSTRACT

In a data processor, an input value having a sign, an exponent and a significand is encoded by determining an exponent difference between a base exponent and the exponent. When the exponent difference is not less than a first threshold, only the exponent difference, or a designated value, is encoded to a payload of the output value and one or more tag bits of the output value are set to a first value. When the exponent difference is less than the first threshold, the significand and exponent difference are encoded to the payload of an output value and, optionally, the one or more tag bits of the output value. A sign bit in the output value is set corresponding to the sign of the input value, and the output value is stored.

### BACKGROUND

A Block Floating-Point (BFP) number system represents a block of floating-point (FP) numbers by a shared exponent (typically the largest exponent in the block) and right-shifted significands of the block of FP numbers. Computations using BFP can provide improved accuracy compared to integer arithmetic and use fewer computing resources than full floating. However, the range of numbers that can be represented using a BFP format is limited, since small numbers are replaced by zero when the significand are right-shifted too far.

In some applications, such as computational neural networks, input data may have a very large range. The use of BFP in such applications can lead to inaccurate results.

### BRIEF DESCRIPTION OF THE DRAWINGS

The accompanying drawings provide visual representations which will be used to more fully describe various representative embodiments and can be used by those skilled in the art to better understand the representative embodiments disclosed and their inherent advantages. In these drawings, like reference numerals identify corresponding or analogous elements.

FIG. 1 is a representation of a block of Enhanced Block Floating Point (EBFP) numbers, in accordance with various representative embodiments.

FIGS. 2A and 2B are diagrammatic representations of computer storage of an EBFP number, in accordance with various representative embodiments.

FIGS. 3A and 3B are diagrammatic representations of computer storage of an EBFP number, in accordance with various representative embodiments.

FIG. 4 is a block diagram of an apparatus for converting a floating-point number into an enhanced block floating-point number, in accordance with various representative embodiments.

FIG. 5 is a block diagram of an exponent unit, in accordance with various representative embodiments.

FIG. 6 is a block diagram of an encoder, in accordance with various representative embodiments.

FIG. 7 is a flow chart of a computer-implemented method 700 for converting a floating-point (FP) number into an enhanced block floating point (EBFP) number, in accordance with various representative embodiments.

FIG. 8 is a flow chart of a method for encoding a significand to a EBFP number, in accordance with various representative embodiments.

FIG. 9 is a flow chart of a method for encoding an exponent difference to a EBFP number, in accordance with various representative embodiments.

FIG. 10 is a flow chart of a method for rounding when converting from a 32-bit floating point number (FP32) to an 8-bit EBFP8r2 number with 8-bits, in accordance with various representative embodiments.

FIG. 11 is a flow chart of a method for converting from a 32-bit floating point number (FP32) to an 8-bit EBFP8r2 number with 8-bits, in accordance with various representative embodiments.

### DETAILED DESCRIPTION

The various apparatus and devices described herein provide mechanisms for data processing using and enhanced block floating point data format.

While this present disclosure is susceptible of embodiment in many different forms, there is shown in the drawings and will herein be described in detail specific embodiments, with the understanding that the embodiments shown and described herein should be considered as providing examples of the principles of the present disclosure and are not intended to limit the present disclosure to the specific embodiments shown and described. In the description below, like reference numerals are used to describe the same, similar or corresponding parts in the several views of the drawings. For simplicity and clarity of illustration, reference numerals may be repeated among the figures to indicate corresponding or analogous elements.

A number may be represented as (−1)^{s}×m×b^{e}, where s is a sign value, m is a significand, e is an exponent and b is a base. In some binary (b=2) floating-point representations, such as the 32-bit IEEE format, the significand is either zero or in the range 1≤m<2. For non-zero values of m, the value m−1 is referred to as the fractional part of the significand. The 32-bit IEEE format stores the exponent as an 8-bit value and the significand as a 23-bit value.

A Block Floating-Point (BFP) number system represents a block of floating-point (FP) numbers by a shared exponent (typically the largest exponent in the Block) and right-shifted significands of the block of FP numbers. The present disclosure improves upon BFP by representing small FP numbers (that would ordinarily be set to zero) by the difference between the exponent and the shared exponent. A tag bit indicates whether the EBFP number represents a shifted significand or the exponent difference.

Some data processing applications, such as Neural Network (NN) processing, require very large amounts of data. For example, a single network architecture can use millions of parameters. Consequently, there is great interest in storing data as efficiently as possible. In some applications, for example, 8-bit scaled integers are used for inference but data for training requires the use of floating-point numbers with a greater exponent range than the 16-bit IEEE half-precision format, which has only 5 exponent bits. A 16-bit “Bfloat” format has been used successfully for NN training tasks. The Bfloat format has a sign bit, 8 exponent bits, and 7 fraction bits (denoted as s,8e,7f). Other FP formats have been proposed recently, including “DLfloat” which has 6 exponent bits and 9 fraction bits (s,6e,9f) as well as other 8-bit formats having more exponent bits than fraction bits (such as s,4e,3f and s,5e,2f). Block Floating-Point (BFP) representation has been used in a variety of applications, such as NN and Fast Fourier Transforms. In BFP, a block of data shares a common exponent, typically the largest exponent of the block to be processed. The significands of FP numbers are right-shifted by the difference between their individual exponents and the shared exponent. BFP has the added advantage that arithmetic processing can be performed on integer data paths saving considerable power and area in NN hardware implementation. BFP appears particularly well-suited to computing dot products because numbers with smaller exponents will not contribute many bits, if any, to the result. However, a difficulty with using BFP for processing Convolutional Neural Networks (CNNs) is that output feature maps are derived from multiple input feature maps which can have widely differing numeric distributions. In this case, many or even most of the numbers in a BFP scheme for encoding feature maps could end up being set to zero. By contrast, the weights employed in CNNs are routinely normalized to the range −1 . . . +1. Given that successful training and inference is usually dependent on the highest magnitude parameter of each filter, blocks of weights need exponents to sit only within a relatively small range.

TABLE 1 shows an example dot product computation for vector operands A and B. The number are denoted by hexadecimal significands with radix 2 exponents. Corresponding decimal significands and exponents are shown in brackets. The maximum of each vector is shown in bold font.

TABLE 1
Dot Product for Real Numbers

| Op A | Op B | OpA × OpB |
|---|---|---|
| +0 × 1.39p − 17 (1.22 × 2⁻¹⁷) | −0 × 1.40p − 5 (−1.25 × 2⁻⁵) | −0 × 1.8740p − 22 (−1.53 × 2⁻²²) |
| −0 × 1.ccp + 20 (−1.80 × 2²⁰) | +0 × 1.fap − 6 (1.98 × 2⁻⁶) | −0 × 1.c69cp + 15 (−1.78 × 2¹⁵) |
| +0 × 1.bbp + 7 (1.73 × 2⁷) | +0 × 1.dep + 19 (1.87 × 2¹⁹) | +0 × 1.9d95p + 27 (1.62 × 2²⁷) |
| −0 × 1.d8p + 11 | −0 × 1.49p + 0 | +0 × 1.2f4cp + 12 |
| +0 × 1.dfp − 12 | +0 × 1.8cp − 10 | +0 × 1.727ap − 21 |
| −0 × 1.d9p + 19 (−1.85 × 2¹⁹) | −0 × 1.0ap + 9 | +0 × 1.eb7ap + 28 |
| +0 × 1.f2p − 17 | −0 × 1.41p + 13 (−1.25 × 2¹³) | −0 × 1.3839p − 3 |
| +0 × 1.d1p − 7 | +0 × 1.ecp − 20 | +0 × 1.bed6p − 26 |
| | Result | +0 × 1.5d1bp + 29 |

TABLE 2 shows the same dot product computation for vector operands A and B performed using Block Floating Point arithmetic. In this example, the dot product is calculated as zero because a number of small operands are represented by zero in the Block Floating Point format.

TABLE 2
Dot Product using Block Floating Point

| Op A (p + 20) | Op B (p + 19) | Op A × Op B |
|---|---|---|
| 0 | 0 | 0 |
| −0 × 1.cc (−1.80) | 0 | 0 |
| 0 | +0 × 1.de (1.87) | 0 |
| 0 | 0 | 0 |
| 0 | 0 | 0 |
| −0 × 0.ed (−0.93) | 0 | 0 |
| 0 | −0 × 0.05 (−0.02) | 0 |
| 0 | 0 | 0 |
| | BFP Result | 0 |

This example illustrates that conventional Block Floating Point arithmetic is not well suited for use where the data has a large range of values.

The present disclosure uses a number format, referred to as Enhanced Block Floating Point (EBFP). The format may be used in applications such as convolutional neural networks where (i) individual feature maps have widely differing numeric distributions and (ii) filter kernels only require their larger parameters to represented with higher accuracy.

In accordance with various embodiments, the exponent of a floating number to be encoded is compared with the shared exponent: when the difference is large enough that the BFP representation would be zero due to all the significand bits being shifted out of range, the exponent difference is stored; otherwise, the suitably encoded significand is stored.

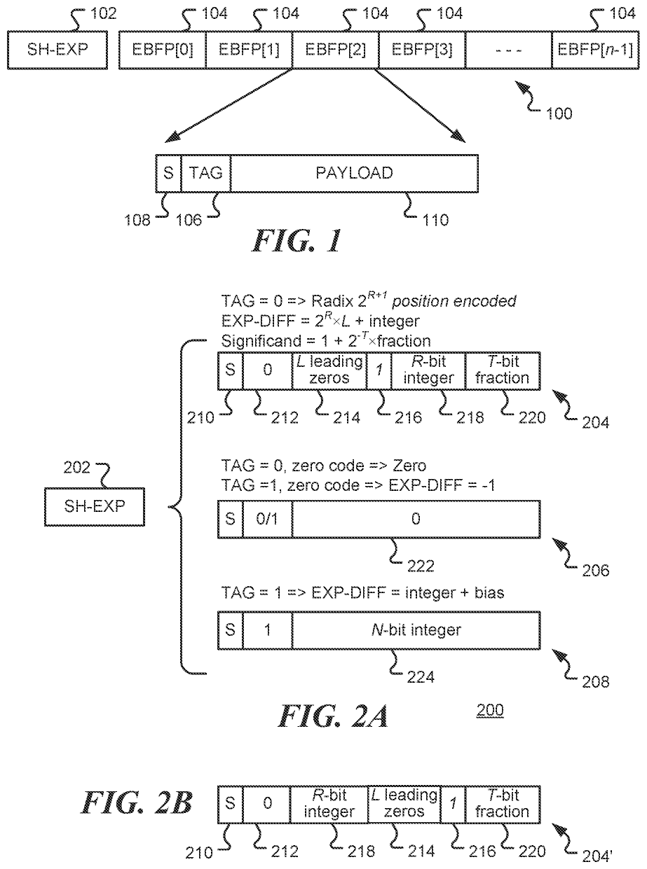

FIG. 1 is a representation of a block of Enhanced Block Floating Point (EBFP) numbers 100. Each number is represented by shared exponent 102 and an M-bit word 104, where M is an integer such as 8 or 16 for example. Word 104 includes one or more tag bits 106, a sign bit 108 and a number of bits for storing a payload 110 indicative of either the exponent difference or an encoded significand. For example, a number may be represented by an 8-bit base exponent and an 8-bit word having one or two tag bits, a sign bit and 5 or 6 bits for storing either the exponent difference or the encoded significand. In this example, the EBFP format implements a floating-point number system with 5 or 6 exponent bits and 1 to 6 significand bits. In contrast to prior formats, the allocation of payload bits between exponent bits and significand bits is variable.

In accordance with an embodiment of the disclosure, a number in floating-point format is converted to a number in EBFP format in a data processor. An input value having a sign, an exponent and a significand is encoded by determining an exponent difference between a base exponent and the exponent, setting one or more tag bits of an output value based on the exponent difference. When the exponent difference is less than a first threshold, the significand and exponent difference are encoded to a payload of the output value. When the exponent difference is not less than the first threshold, only the exponent difference is encoded to the payload of the output value. A sign bit in the output value is set corresponding to the sign of the input value, and the output value is stored.

The EBFP format is described in more detail below with reference to an apparatus for converting a floating-point (FP) number to an EBFP. In addition to the encoding scheme, two other aspects of EBFP are described: (a) rounding, and (b) special values. Rounding can be employed when converting a floating-point number into EBFP to preserve as much accuracy as possible. In one embodiment, a round-to-nearest scheme is used (ties away; i.e. round up when the guard bit is set) so that the upper fraction bits of 8-bit and 16-bit EBFP numbers are the same for all numbers. Other schemes may be used, such as IEEE round-to-nearest (ties nearest even) or performing a logic OR operation between the guard bit and the significand least significant bit (lsb). Rounding can occur across the boundary between the two EPFP representations. The largest exponent difference that can be represented with 5 bits is 31. In one embodiment of EBFP, this value represents zero when the sign bit is 0 or (optionally) Not a Number (IEEE NaN or unsigned Infinity) when the sign bit is 1.

FIG. 2A is a diagrammatic representation of computer storage 200 of an EBFP number, in accordance with various representative embodiments. The embodiment shown uses a single tag bit. The storage includes a shared exponent (SH-EXP) 202 and payloads (selectable words) 204, 206 and 208.

First word 204 includes sign bit 210, 1-bit tag 212, and a payload consisting of fields 214, 216, 218 and 220. The tag bit 212 is set to zero to indicate that the payload is associated with a significand. Fields 214, 216 and 218 indicate a difference between the shared exponent 202 and the exponent of the number being represented. Field 214 contains L zeros, where L may be zero. Field 216 contains a “one” bit, and field 218 contains an R-bit integer, where R is a designated integer. The factor 2^{(R+1)} is called the “radix” of the representation, so the radix is 2 when R=0 , 4 when R=1, and 8 when R=2. Field 218 is omitted when R=0. The exponent difference is given by 2^{R}×L+P . Field 220 is a rounded and right-shifted fractional part of the significand. The total number of bits in the payload is fixed. Since the number of zeros in field 214 is variable, the number of bits, T, in fraction field varies accordingly. When the integer value of field 220 is F, the significand is given 1+2^{-T}×F, which may be denoted by 1.fff . . . f. Thus, when the shared exponent is se, the number represented is case:

x=2^{se}×2⁻⁽²^{^{R}}^{L+P)}×(1+2^{-T}×F).

In one embodiment, the designated number R is zero and the radix is two. In this

x=2^{se}×2^{-L}(1+2^{-T}×F),

and the payload is simply the right-shifted significand. The exponent difference may be determined by counting the number of leading zeros in the EBFP number.

In second payload 206, the payload 222 is set to zero. When the tag bit is zero, the payload represents the number zero. When the tag bit is one, the payload represents an exponent difference of −1. This can occur when rounding causes the maximum value to overflow. Thus, the number represented is 2^{se+1}.

In payload 208, the tag bit is set to one to indicate that the payload 224 relates only to the exponent difference. When the payload is an integer E, the number represented is 2^{se+E+bias}, where bias is an offset or bias value. The bias value is included since some small values of exponent difference can represented by payload 204.

TABLE 3 shows how output values are produced based on an exponent difference for an example implementation where the payload has 8 bits and includes a sign bit, a tag bit and 6 payload bits. In this example, R=0, so the radix is 2. The format is designated “8r2”. In the table below, “f” denotes fractional bit of the input value and “e” denotes one bit of the biased exponent difference.

TABLE 3
EBFP 8r2, 1-bit tag Format

| | Rounded | Output | Notes: |
|---|---|---|---|
| Exponent | & Shifted | Sign, Tag, | R = 0, |
| Difference | Significand | Payload [5:0] | exp-diff = L |
| 0 | 1.fffff | s 0 1fffff | L = 0 |
| 1 | 1.ffff | s 0 01ffff | L = 1 |
| 2 | 1.fff | s 0 001fff | L = 2 |
| 3 | 1.ff | s 0 0001ff | L = 3 |
| 4 | 1.f | s 0 00001f | L = 4 |
| 5 | 1.0 | s 0 000001 | L = 5 |
| Any | Zero | X 0 000000 | |
| 0 | 10.0 | s 1 000000 | Overflow due to rounding |
| 6 − 68 | Any | s 1 eeeeee | exp-diff = 6 + eeeeee |
| >68 | Any | 0 1 111111 | Underflow |
| | NaN | 1 1 111111 | Not a number |

For zero tag, the bits indicated in bold font indicate the encoding of the exponent difference. In this example, the payload is equivalent to a right-shifted significand, including an explicit leading bit. Note that for an exponent difference greater than 5, the right-shifted significand is lost because of the limited number of bits. For an exponent difference greater than 5, only the exponent difference is encoded with a bias of 6.

In the coding of the tag and exponent difference, each bit has two states indicated by 1 and 0. It will be apparent to those of skill in the art that, herein, the states may equivalently be represented by 0 and 1.

In the embodiment shown in TABLE 3, the exponent difference can be decoded from the EBFP number by counting the number of leading zeros in the payload. This operation is denoted as CLZ(payload).

TABLE 4 shows the result of the example dot product computation described above. The exponents and signs of FP values with smaller exponents are retained. The resulting error compared to the true result is 13%. This is much improved compared to conventional BFP, which gave the results as zero. The accuracy of the EBFP approach is sufficient for many applications, including training convolutional neural networks.

TABLE 4
Dot Product using Enhanced Block Floating Point

| Op A (p + 20) | Op B (p + 19) | Op A × Op B |
|---|---|---|
| +0 × 1.0p − 17 (1.00 × 2⁻¹⁷) | −0 × 1.0p − 5 (−1.00 × 2⁻⁵) | −0 × 1.0p − 22 (−1.00 × 2⁻²²) |
| −0 × 1.cc (−1.80 × 2²⁰) | +0 × 1.0p − 6 (1.00 × 2⁻⁶) | −0 × 1.ccp + 14 (−1.80 × 2¹⁴) |
| +0 × 1.0p + 7 (1.00 × 2⁷) | +0 × 1.de (1.87 × 2¹⁹) | +0 × 1.dep + 26 (1.87 × 2²⁶) |
| −0 × 1.0p + 11 (−1.00 × 2¹¹) | −0 × 1.0p + 0 (−1.00 × 2⁰) | +0 × 1.0p + 11 (1.00 × 2¹¹) |
| +0 × 1.0p − 12 (1.00 × 2⁻¹²) | +0 × 1.0p − 10 (1.00 × 2⁻¹⁰) | +0 × 1.0p − 22 (1.00 × 2⁻²²) |
| −0 × 0.ed (−0.93 × 2²⁰) | −0 × 1.0p + 9 (1.00 × 2⁹) | +0 × 1.dap + 28 (1.85 × 2²⁸) |
| +0 × 1.0p − 17 (1.00 × 2⁻¹⁷) | −0 × 0.05 (−0.02 × 2¹⁹) | −0 × 1.40p − 4 (−1.40 × 2⁻⁴) |
| +0 × 1.0p − 7 (1.00 × 2⁻⁷) | +0 × 1.0p − 20 (1.00 × 2⁻²⁰) | +0 × 1.0p − 27 (1.00 × 2⁻²⁷) |
| | EBFP Result | +0 × 1.28bdp + 29 (1.16 × 2²⁹) |

FIG. 2B is a diagrammatic representation of computer storage 204′ of an EBFP number, in accordance with various representative embodiments. EBFP format includes a number of fields. The order of the fields maybe varied without departing from the present disclosure. For example, in FIG. 2B, the R-bit integer field 218 follows the tag field 212. The “one” field 216 is used to terminate the L-leading zeros field 214. This field has a variable length. The length of field 220 varies accordingly, with L+T being constant. Other variations will be apparent to those of ordinary skill in the art. In general, the exponent difference and fractional part (if any) are encoded to produce a tag and a payload, with the tag indicating how the payload is to be interpreted.

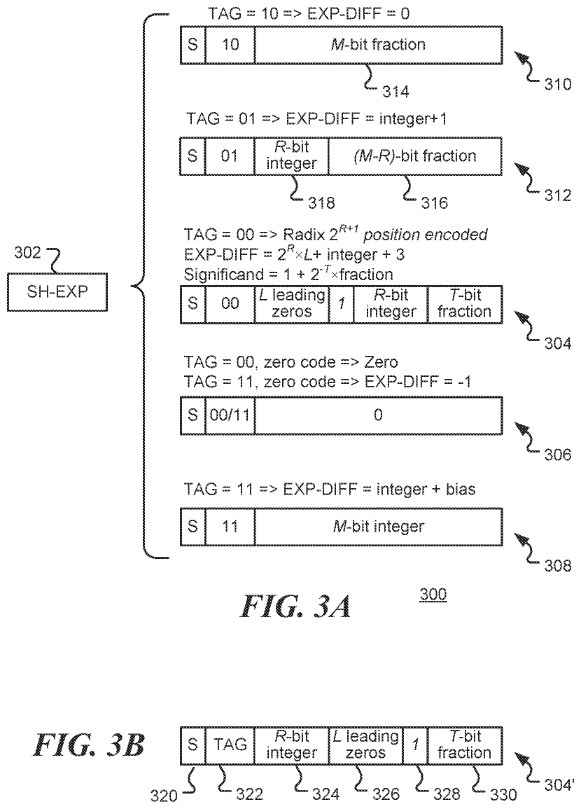

FIG. 3A is a diagrammatic representation of computer storage 300 of an EBFP number, in accordance with various representative embodiments. The embodiment shown uses a 2-bit tag. The storage includes a shared exponent (SH-EXP) 302 and selectable payloads 304, 306, 308, 310, and 312. Payloads 304, 306, 308 correspond to payloads 204, 206 and 208 in the format with a 1-bit tag. However, the bias may be different. The length of the payload is 1-bit shorter because of the extra tag bit. The format includes a first additional payload 310, identified by a tag 10, that stores the fractional part 314 of the significand rounded to M-bits, where M is the length of the payload field. The exponent difference is zero. The format also includes a second additional payload 312, identified by a tag 01, that stores the fractional part 316 of the significand rounded to (M-R+1)-bits, together with an R-bit integer 318. The exponent difference is one. For R=1, the payload is the rounded significand and the exponent difference is one. For R=2, the exponent difference is one when the first bit of the payload is zero, and two when the first bit of the payload is one.

TABLE 5 shows how output values are produced based on an exponent difference for an example implementation where the payload has 8 bits and includes a sign bit, two tag bits and 5 payload bits. In this example, R=0. In the table below, “f” denotes fractional bit of the input value and “e” denotes one bit of the biased exponent difference. Is this embodiment, the exponent difference can be decoded from the EBFP number by counting the number of leading zeros in the tag and payload. This operation is denoted as CLZ(tag, payload).

TABLE 5
EBFP 8r2, 2-bit tag Format

| | Rounded | Output Sign, | | Notes: |
|---|---|---|---|---|
| Exponent | & Shifted | Tag[1:0], | | R = 0, |
| Difference | Significand | Payload[4:0] | | exp-diff = CLZ(tag, payload) |
| 0 | 1.fffff | s 10 | fffff | CLZ(tag, payload) = 0 |
| 1 | 1.fffff | s 01 | fffff | CLZ(tag, payload) = 1 |
| 2 | 1.ffff | s 00 | 1ffff | CLZ = 2 |
| 3 | 1.fff | s 00 | 01fff | CLZ = 3 |
| 4 | 1.ff | s 00 | 001ff | CLZ = 4 |
| 5 | 1.f | s 00 | 0001f | CLZ = 5 |
| 6 | 1.0 | s 00 | 00001 | CLZ = 6 |
| | Zero | X 00 | 00000 | |
| 0 | 10.00000 | s 11 | 00000 | Overflow due to rounding |
| | | | | (L = −1) |
| 7-37 | Any | s 11 | eeeee | exp-diff = 7 + eeeee |
| >37 | Any | 0 11 | 11111 | Underflow |
| | NaN | 1 11 | 11111 | Not a number |

TABLES 1 and 2 above, illustrate how an output payload can be obtained from an exponent difference and a significand.

TABLE 6 shows how output values are produced based on an exponent difference for an example implementation where the payload has 8 bits and includes a sign bit, a tag bit and 6 payload bits. In this example, R=1, so the radix is 4. In the table below, “f” denotes fractional bit of the input value and “e” denotes one bit of the biased exponent difference.

TABLE 6
EBFP 8r4, 2-bit tag Format

| Exponent | Rounded | Output Sign, | | Notes: |
|---|---|---|---|---|
| Difference | & Shifted | Tag[1:0], | | R = 1, |
| p = 0 or 1 | Significand | Payload[4:0] | | exp-diff = CLZ(tag, payload) |
| 0 | 1.fffff | s 10 | fffff | Special case: p = 1 is assumed |
| 1 + p | 1.ffff | s 01 | pffff | CLZ = 1 |
| 3 + p | 1.fff | s 00 | 1pfff | CLZ = 2 |
| 5 + p | 1.ff | s 00 | 01pff | CLZ = 3 |
| 7 + p | 1.f | s 00 | 001pf | CLZ = 4 |
| 9 + p | 1.0 | s 00 | 0001p | CLZ = 5 |
| 11 | 1.0 | s 00 | 00001 | CLZ = 6, hidden p = 0 |
| | Zero | X 00 | 00000 | |
| 0 | 10.0 | s 11 | 00000 | Overflow due to rounding |
| 12-42 | Any | s 11 | eeeee | exp-diff = 12 + eeeee |
| >42 | Any | 0 11 | 11111 | Underflow |
| | NaN | 1 11 | 11111 | Not a number |

In the examples above, the significand is stored to the right of the encoded exponent difference. It will be apparent to those of ordinary skill in the art that alternative arrangements may be used without departing from the present disclosure. For example, in one embodiment, the significand is stored to the left of the encoded exponent difference, and the encoded exponent difference includes L trailing zeros. This is shown in TABLE 7A below. For the encoded exponent in this embodiment the use of one and zeros is reversed. The exponent difference can be decoded by counting the number of trailing zeros in the tag and payload. The exponent difference is decoded as 2×CTZ(tag, payload)+p−1.

TABLE 7A
Alternative EBFP 8r4, 2-bit tag Format

| Exponent | Rounded | Output Sign, | | R = 1, |
|---|---|---|---|---|
| Difference | & Shifted | Tag[1:0], | | exp-diff = |
| p = 0 or 1 | Significand | Payload[4:0] | | 2 × CTZ(tag, payload) + p − 1 |
| 0 | 1.fffff | s fffff | 11 | CTZ = 0, p = 1 |
| 1 + p | 1.ffff | s ffffp | 10 | CTZ =1 |
| 3 + p | 1.fff | s fffp1 | 00 | CTZ = 2 |
| 5 + p | 1.ff | s ffp10 | 00 | CTZ = 3 |
| 7 + p | 1.f | s fp100 | 00 | CTZ = 4 |
| 9 + p | 1.0 | s p1000 | 00 | CTZ = 5 |
| 11 | 1.0 | s 10000 | 00 | CTZ = 6, hidden p = 0 |
| | Zero | X 00000 | 00 | |
| 0 | 10.0 | s 00000 | 01 | Overflow due to rounding |
| 12-42 | Any | s eeeee | 01 | |
| >42 | Any | 0 11111 | 01 | Underflow |
| | NaN | 1 11111 | 01 | Not a number |

The payload is made up an encoded exponent difference (shown in bold font) concatenated with a number (possibly 0) of fraction bits (ff . . . f), where the encoded exponent difference includes a number (possibly 0) of bits set to zero, at least one bit set to one, and a number (possibly 0) of additional bits (p).

FIG. 3B is a diagrammatic representation of computer storage 304′ of an EBFP number, in accordance with various representative embodiments. In FIG. 3B, the order of the fields is changed, with the R-bit integer field 324 following the tag field 322. The “one” field 328 is used to terminate the L-leading zeros field 326. Examples of this arrangement are discussed in more detail below.

TABLE 7B, below, shows an example encoding using storage 304′ in FIG. 3B. In this example, the exponent difference is given by 2^{R}×(CLZ+tag)+p, when tag=01, and by 2^{R}×tag+p when tag=00 or 01 (R=1 in this example).

TABLE 7B
Alternative EBFP 8r4, 2-bit tag (R = 1) Format

| Sign:Tag: | |
|---|---|
| Payload | Floating-Point Equivalent |
| s 11 ddddd | (−1)^{s} × 1.0 × 2\hat{ } (shexp − ddddd − 13) |
| s 11 11111 | (−1)^{s} × 1.0 × 2\hat{ }(shexp + 1) |
| 0 11 00000 | Zero |
| 1 11 00000 | NaN |
| s 00 pffff | (−1)^{s} × 1.fffff × 2\hat{ }(shexp − p) |
| s 01 pffff | (−1)^{s} × 1.ffff × 2\hat{ } (shexp − p − 2) |
| s 10 p1fff | (−1)^{s} × 1.fff × 2\hat{ } (shexp − p − 4) |
| s 10 p01ff | (−1)^{s} × 1.ff × 2\hat{ } (shexp − p − 6) |
| s 10 p001f | (−1)^{s} × 1.f × 2\hat{ } (shexp − p − 8) |
| s 10 p0001 | (−1)^{s} × 1.0 × 2\hat{ }(shexp − p − 10) |
| s 10 p0000 | (−1)^{s} × 1.0 × 2\hat{ } (shexp − p − 12) |

The payload is made up an encoded exponent difference concatenated with a number (possibly 0) of fraction bits (ff . . . f), where the encoded exponent difference includes a number (possibly 0) of bits set to zero, at least one bit set to one, and a number (possibly 0) of additional bits (p).

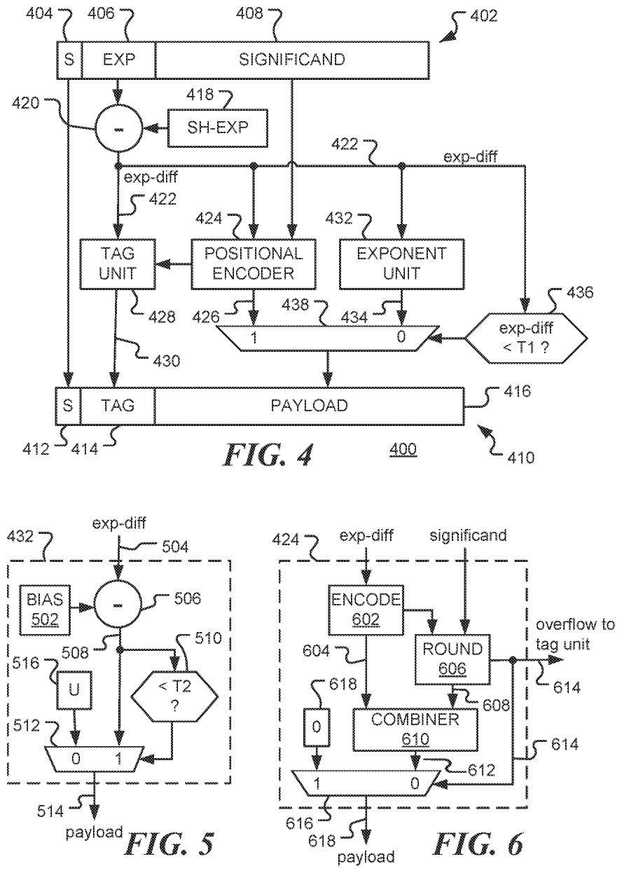

FIG. 4 is a block diagram of an apparatus 400 for converting a floating-point number into an enhanced block floating-point number, in accordance with various embodiments. The floating-point (FP) number 402 is stored as a sign bit 404, an exponent 406 and significand 408. The leading “1” bit in significand 408 may be explicit or hidden. FP number 402 is processed to provide an EBFP output storage 410, which is stored as a sign bit 412, one- or two-bit tag 414, and payload 416. A base or shared exponent value 418 is subtracted, in subtraction unit 420, from exponent 406 of the input value to produce exponent difference 422. Exponent difference 422 is passed to positional encoder 424 that produces a first payload 426, tag unit 428 that produces tag value 430 and exponent unit 432 that produces a second payload 434. The exponent difference is compared to a first threshold in comparator 436. When the exponent different is greater than or equal to the first threshold, selector 438 selects second payload 434 to be stored in the payload field 416 of output storage 410. Otherwise, selector 438 selects first payload 426 to be stored. Tag value 414 indicates whether payload field 416 contains a first or second payload. A 2-bit tag value may also indicate the format of the first payload 426.

In accordance with various representation embodiments, a digital processor includes a subtraction unit, a tag unit, a positional encoder, an exponent unit and output storage. The subtraction unit is configured to determine an exponent difference between a base exponent and an exponent of an input value, the input value having a sign, an exponent and a significand. The tag unit is configured to produce a tag value based, at least in part, on the exponent difference. The positional encoder is configured to produce a first payload based on the significand of the input value and the exponent difference. The exponent unit is configured to produce a second payload from the exponent difference. The output storage is configured to store, as an output value, the tag value, a sign bit indicating the sign of input value and a payload.

The first payload is stored when the exponent difference is less than a first threshold, and the second payload is stored when the exponent difference is not less than the first threshold.

FIG. 5 is a block diagram of an exponent unit 432, in accordance with various embodiments. A bias value 502 is subtracted from an input exponent difference 504 in subtraction unit 506 to produce a biased exponent difference 508. The biased exponent difference 508 is compared to a second threshold in comparator 510. When the biased exponent difference 508 is less than a second threshold T2, selector 512 selects the biased exponent difference 508 as the output payload 514. Otherwise, a designated value 516 (“U”) is selected as the output payload, indicating that the number has underflowed and has been set to zero. In one embodiment, the designated value is the maximum representable number, i.e., all “ones.” In this embodiment, the output payload may be obtained by clipping biased exponent difference 508 at the maximum representable number. Bias value 502 may be selected dependent upon how many exponent differences can be represented in the significand payload format.

FIG. 6 is a block diagram of a positional encoder 424, in accordance with various embodiments. Positional encoder 424 receives the exponent difference and significand as inputs. The exponent difference is encoded in unit 602. The number of bits in resulting code 604 depends upon the exponent difference. The significand is rounded, in unit 606, to a number of bits determined based on the length of exponent difference code 604. The exponent difference code 604 and rounded significand 608 are combined in combiner 610 to produce an output payload 612. In a special case, the significand may overflow when rounded. In this case, a signal 614 is sent to the tag unit to generate a special tag. In addition, selector 616 selects a corresponding designated special code as the final output payload 618. Encoder 424 is referred to as a “positional” encoder since the payload is interpreted dependent upon the position of certain bits in the payload.

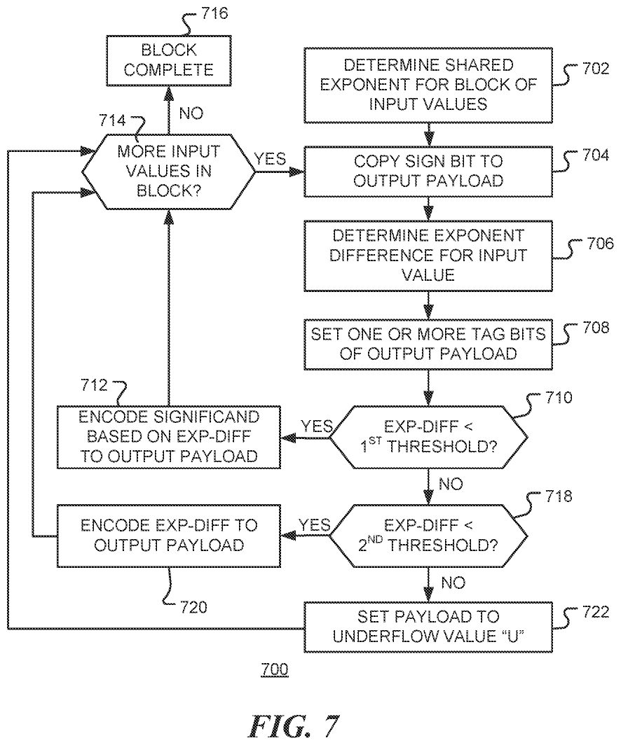

FIG. 7 is a flow chart of a computer-implemented method 700 for converting a floating-point (FP) number into an enhanced block floating point (EBFP) number, in accordance with various embodiments of the disclosure. At block 702 a shared exponent is determined for a block of input values. For example, the shared exponent may be the maximum exponent of the input values. At block 704, a sign bit of the input FP number in the block is copied to a sign bit of the output EBFP number. At block 706, the exponent difference between the shared exponent and the exponent of the input FP number is determined and, at block 708, one or more tag bits of the output EBFP number are set based on the exponent difference. At decision block 710, the exponent difference is compared to a first threshold. When the exponent difference is less than the first threshold, as depicted by the positive branch from decision block 710, the significand of the input FP number is encoded at block 712 based on the exponent difference and stored in the output EBFP number. When there are more FP numbers in the block to be converted, as depicted by the positive branch from decision block 714, flow continues to block 704 to convert another input FP number. Otherwise, conversion of the block is complete, as indicated by block 716.

When the exponent difference is not less than the first threshold, as depicted by the negative branch from decision block 710, flow continues to decision block 718. When the exponent difference of the input FP number is less than a second threshold value, as depicted by the positive branch from decision block 718, the exponent difference is encoded to the output EBFP number at block 720. For example, the output payload may be a biased exponent difference. When the exponent difference of the input FP number is not less than a second threshold value, as depicted by the negative branch from decision block 718, the output payload is set, at block 722, to a designated value to indicate underflow. The resulting EBFP number represents zero. Flow continues to decision block 714.

By this method, the payload in the resulting EBFP number may represent an exponent-difference, an exponent-difference and a significand, or a special value such as zero. The one or more tag bits indicate how the payload is to be interpreted.

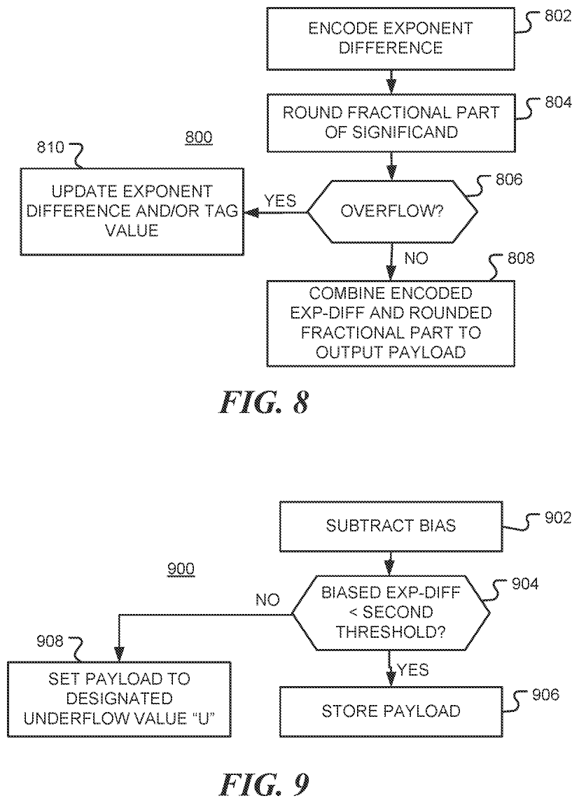

FIG. 8 is a flow chart of a method 800 for encoding a significand to a EBFP number, in accordance with various embodiments. At block 802, an exponent difference is encoded as L zeros, a “one” bit and, optionally, an R-bit integer P, where exponent difference is given by 2^{R}×L+P+offset, as described above. R may have the value zero, in which case the R-bit integer is omitted. For a payload length of Mbits, the significand is rounded to M-L-R-1 bits at block 804. If rounding the significand does not cause it to overflow, as depicted by the negative branch from decision block 806, the output payload is obtained by combining the encoded exponent difference and the rounded significand to produce the output payload at block 808. However, if rounding the significand causes it to overflow, as depicted by the positive branch from decision block 806, the output payload and/or tag are modified at block 810. For example, the exponent difference may be reduced, which, in turn may require the tag value and the encoding scheme to be changed.

FIG. 9 is a flow chart of a method 900 for encoding an exponent difference to a EBFP number, in accordance with various embodiments. At block 902, a bias value is subtracted from the exponent difference of an input value. When the biased exponent difference is less than a second threshold, as depicted by the positive branch from decision block 904, the biased exponent difference is stored, at block 906, as the payload in the output. When the biased exponent difference is not less than a second threshold, as depicted by the negative branch from decision block 904, the payload is set to zero or some other designated value at block 908 to indicate that the FP number has underflowed in the conversion. In one embodiment, the biased exponent difference is clipped to the maximum value when underflow occurs. All of the bits in payload are set to one.

The example number formats described above use 8-bit words. This enables computations to be made using shorter word lengths. This is advantageous, for example, when a large number of values is being processed for when memory is limited. In some applications, such as accumulators, more precision is needed. An EBFP format using 16-bit words is described below. In general, the format using M-bit words, where M can be any number (e.g., 8, 16, 24, 32, 64 etc.).

In one embodiment using 16-bit words, all EBFP16 numbers have an additional eight fraction bits than in EBFP8, while the range of exponent differences is the same as in EBFP8. EBFP16 may be used where a wider storage format is needed and provides better accuracy and a wider exponent range than the “Bfloat” format.

TABLE 8 below gives an example of an EBFP16r2 (radix 2) format with two tag bits. Note that for exponent differences in the range 7-37, the last eight bits of the payload contain the fractional part of the number, while the first 5 bits contain the exponent. In this case, the payload is similar to floating point representation of the input, except that the exponent is to be subtracted from the shared exponent.

TABLE 8

| | Rounded | Output Sign, |
|---|---|---|
| Exponent | & Shifted | Tag[1:0], |
| Difference | Significand | Payload[12:0] |
| 0 | 1.fffff ffffffff | s 10 fffff ffffffff |
| 1 | 1.fffff ffffffff | s 01 fffff ffffffff |
| 2 | 1.ffff ffffffff | s 00 1ffff ffffffff |
| 3 | 1.fff ffffffff | s 00 01fff ffffffff |
| 4 | 1.ff ffffffff | s 00 001ff ffffffff |
| 5 | 1.f ffffffff | s 00 0001f ffffffff |
| 6 | 1.ffffffff | s 00 00001 ffffffff |
| | Zero | X 00 00000 xxxxxxxx |
| 0 | 10.0 | s 11 00000 xxxxxxxx |
| 7-37 | 1.ffffffff | s 11 eeeee ffffffff |

TABLE 9 below gives an example of an EBFP16r4 (radix 4) format with two tag bits.

TABLE 9

| Exponent | Rounded | Output Sign, |
|---|---|---|
| Difference | & Shifted | Tag[1:0], |
| p = 0 or 1 | Significand | Payload[12:0] |
| 0 | 1.fffff ffffffff | s 10 fffff ffffffff |
| 1 + p | 1.ffff ffffffff | s 01 pffff ffffffff |
| 3 + p | 1.fff ffffffff | s 00 1pfff ffffffff |
| 5 + p | 1.ff ffffffff | s 00 01pff ffffffff |
| 7 + p | 1.f ffffffff | s 00 001pf ffffffff |
| 9 + p | 1.ffffffff | s 00 0001p ffffffff |
| 11 | 1.ffffffff | s 00 00001 ffffffff |
| | Zero | X 00 00000 xxxxxxxx |
| 0 | 10.0 | s 11 00000 xxxxxxxx |
| 12-42 | 1.ffffffff | s 11 eeeee ffffffff |

In one embodiment, an EBFP number is encoded in a first format of the form “s:tag:P:1:F” or second format of the form “s:tag:D”. where “s” is a sign-bit, “tag” is one or more bits of an encoding tag, “P” is R encoded exponent difference bits, “F” is a fraction and “D” is an exponent difference. Except for a subset of tag values, the floating-point number represented has significand 1.F and exponent difference 2^{R}×(tag+CLZ)+P, where CLZ is the number of leading zeros in the fraction F. For a first special tag value (e.g., all ones), the second format is used where the exponent difference is D plus a bias offset.

Some example embodiments for an 8-bit EBFP number are given below in TABLE 10.

TABLE 10
1-bit tag, R = 0

| Tag: | |
|---|---|
| Payload | Floating-Point Equivalent |
| 1 dddddd | 1.0 * 2\hat{ }(shexp − dddddd − 5) |
| 1 111111 | 1.0 * 2\hat{ }(shexp + 1) |
| 1 000000 | Zero |
| 0 1fffff | 1.fffff * 2\hat{ }shexp |
| 0 01ffff | 1.ffff * 2\hat{ } (shexp − 1) |
| 0 001fff | 1.fff * 2\hat{ }(shexp − 2) |
| 0 0001ff | 1.ff * 2\hat{ }(shexp − 3) |
| 0 00001f | 1.f * 2\hat{ }(shexp − 4) |
| 0 000001 | 1.1 * 2\hat{ }(shexp − 5) |
| 0 000000 | 1.0 * 2\hat{ } (shexp − 5) |

In contrast with the embodiments discussed above, the positions of the one or more “p” bits are fixed as the leading bits in the payload. With an 8-bit data, R may be in the range 0-5. Some examples are listed below in TABLES 11-15.

TABLE 11
1-bit tag, R = 1

| Tag: | |
|---|---|
| Payload | Floating-Point Equivalent |
| 1 dddddd | 1.0 * 2\hat{ }(shexp − dddddd − 8) |
| 1 111111 | 1.0 * 2\hat{ } (shexp + 1) |
| 1 000000 | Zero |
| 0 p1ffff | 1.ffff * 2\hat{ }(shexp − p) |
| 0 p01fff | 1.fff * 2\hat{ }(shexp − p − 2) |
| 0 p001ff | 1.ff * 2\hat{ }(shexp − p − 4) |
| 0 p0001f | 1.f * 2\hat{ }(shexp − p − 6) |
| 0 p00001 | 1.1 * 2\hat{ }(shexp − p − 8) |
| 0 p00000 | 1.0 * 2\hat{ }(shexp − p − 8) |

TABLE 12
2-bit tag, R = 0

| Tag: | |
|---|---|
| Payload | Floating-Point Equivalent |
| 11 ddddd | 1.0 * 2\hat{ } (shexp − ddddd − 6) |
| 11 11111 | 1.0 * 2\hat{ }(shexp + 1) |
| 11 00000 | Zero |
| 00 fffff | 1.fffff * 2\hat{ }shexp |
| 01 fffff | 1.fffff * 2\hat{ } (shexp − 1) |
| 10 1ffff | 1.ffff *2\hat{ }(shexp − 2) |
| 10 01fff | 1.fff * 2\hat{ }(shexp − 3) |
| 10 001ff | 1.ff * 2\hat{ }(shexp − 4) |
| 10 0001f | 1.f * 2\hat{ }(shexp − 5) |
| 10 00001 | 1.1 * 2\hat{ }(shexp − 6) |
| 10 00000 | 1.0 * 2\hat{ }(shexp − 6) |

TABLE 13
2-bit tag, R = 1

| Tag: | |
|---|---|
| Payload | Floating-Point Equivalent |
| 11 ddddd | 1.0 * 2\hat{ }(shexp − ddddd − 10) |
| 11 11111 | 1.0 * 2\hat{ }(shexp + 1) |
| 11 00000 | Zero |
| 00 pffff | 1.fffff * 2\hat{ } (shexp − p) |
| 01 pffff | 1.ffff * 2\hat{ } (shexp − p − 23) |
| 10 p1fff | 1.fff * 2\hat{ }(shexp − p − 4) |
| 10 p01ff | 1.ff * 2\hat{ }(shexp − p − 6) |
| 10 p001f | 1.f * 2\hat{ }(shexp − p − 8) |
| 10 p0001 | 1.1 * 2\hat{ } (shexp − p − 10) |
| 10 p0000 | 1.0 * 2\hat{ }(shexp − p − 10) |

TABLE 14
1-bit tag, R = 2

| Tag: | |
|---|---|
| Payload | Floating-Point Equivalent |
| 1 dddddd | 1.0 * 2\hat{ } (shexp − dddddd − 15) |
| 1 111111 | 1.0 * 2\hat{ }(shexp + 1) |
| 1 000000 | Zero |
| 0 pp1fff | 1.fff * 2\hat{ }(shexp − pp) |
| 0 pp01ff | 1.ff * 2\hat{ }(shexp − pp − 4) |
| 0 pp001f | 1.f * 2\hat{ }(shexp − pp − 8) |
| 0 pp0001 | 1.1 * 2\hat{ }(shexp − pp − 12) |
| 0 pp0000 | 1.0 * 2\hat{ }(shexp − pp − 12) |

TABLE 15
3-bit tag, R = 1

| Tag: | |
|---|---|
| Payload | Floating-Point Equivalent |
| 111 dddd | 1.0 * 2\hat{ }(shexp − dddd − 16) |
| 111 1111 | 1.0 * 2\hat{ } (shexp + 1) |
| 111 0000 | Zero |
| 110 p1ff | 1.ff * 2\hat{ } (shexp − p − 12) |
| 110 p01f | 1.f * 2\hat{ }(shexp − p − 14) |
| 110 p00f | 1.f * 2\hat{ }(shexp − p − 16) |
| xxx pfff | 1.fff * 2\hat{ }(shexp − p − 2*xxx) |

In TABLE 15, “xxx” is any 3-bit combination except for the special values “111” and“110”.

Still further embodiments are given in TABLES 16-18.

TABLE 16
3-bit Tag

| | |
|---|---|
| 111 dddd | 1.0 * 2\hat{ } (shexp-21 − dddd) |
| 111 1111 | 1.0 * 2\hat{ }(shexp + 1) |
| 111 0000 | e.g. Zero (S = 0); NaN/Inf (S = 1) |
| 0tt pfff | 1.fff * (2\hat{ }shexp − ttp) |
| 10t ppff | 1.ff * (2\hat{ }shexp − tpp − 8) |
| 110 p1ff | 1.ff * 2\hat{ } (shexp − p − 16) |
| 110 p01f | 1.f * 2\hat{ }(shexp − p − 18) |
| 110 p00f | 1.f * 2\hat{ } (shexp − p − 20) |

TABLE 17
4-bit Tag

| 0ttt fff | 1.fff * 2\hat{ }(shexp − ttt) |
|---|---|
| 10tt pff | 1.ff * 2\hat{ }(shexp − ttp − 8) |
| 110t pff | 1.ff * 2\hat{ }(shexp − tp − 16) |
| 1110 ppf | 1.f * 2\hat{ }(shexp − pp − 20) |
| 1111 ddd | 1.0 * 2\hat{ } (shexp − 23 − ddd) |
| 1111 111 | 1.0 * 2\hat{ } (shexp + 1) |
| 1111 000 | Zero (S = 0); NaN/Inf (S = 1) |

TABLE 18
4-bit Tag (0↔1)

| 1ttt fff | 1.fff * 2\hat{ } (shexp − ttt) |
|---|---|
| 01tt pff | 1.ff * 2\hat{ }(shexp − ttp − 8) |
| 001t pff | 1.ff * 2\hat{ } (shexp − tp − 16) |
| 0001 ppf | 1.f * 2\hat{ }(shexp − pp − 20) |
| 0000 ddd | 1.0 * 2\hat{ }(shexp − 23 − ddd) |
| 0000 111 | 1.0 * 2\hat{ } (shexp + 1) |
| 0000 000 | Zero (S = 0); NaN/Inf (S = 1) |

TABLE 18 is equivalent to TABLE 17 and illustrates how the use of zero and one in the part of the encoding shown in bold font may be reversed.

To improve accuracy when the number of fraction bits is reduced, rounding is used. Examples of rounding a 16-bit floating point number into EBFP8r2 and EBFP16r2 formats are now described. Bits shown in bold font are encoded in both EBFP8 and EBP16 formats. For clarity, these nits are separated by a space from the 8 trailing bits.

Example 1: Floating-point number=+1.11010 10011111 01×2^{sh-exp}.

For upper bits, the guard bit is G=1, while for the lower bits the guard bit is G=0. Thus, the EBFP8 format is: 0 10 11011, and the EBFP16 format is: 0 10 11011 10011111. In the EBFP format, 1 denotes a negative, 2′s-complement, most significant bit of the lower bits.

Example 2: Floating-point number=+1.1101 01001111 101×2^{(sh-exp-2)}.

For the upper bits, the guard bit is G=0, while for lower bits the guard bit is G=1. Thus, the EBFP8 formatted number is: 0 00 11101, and the EBFP16 formatted number is: 00 11101 01010000.

Rounding to Nearest (Ties Away) generally results in the same most significant bits for both EBFP8 fraction bits as for EBFP16. However, there are some ‘corner’ cases.

Example 3: Floating-point number=+1.1111 0111111 111×2^{(sh-exp-2)}.

In this example, rounding the lower bits causes G=1 for upper bits. Thus, the EBFP8 formatted number is: 0 00 11111, and the EBFP16 formatted number is: 0 01 00000 10000000. However, this is equivalent to 0 00 11111 10000000 (but with positive most significant bit in lower 8 bits). In this case, the EBFP8 and EBFP16 MSB's do not match but are numerically equal. In one embodiment, when rounding from EBFP16 to EBFP8, the EBFP8 payload is decremented if the bottom 8 bits of EBFP16==0×80. Otherwise, the payload is truncated.

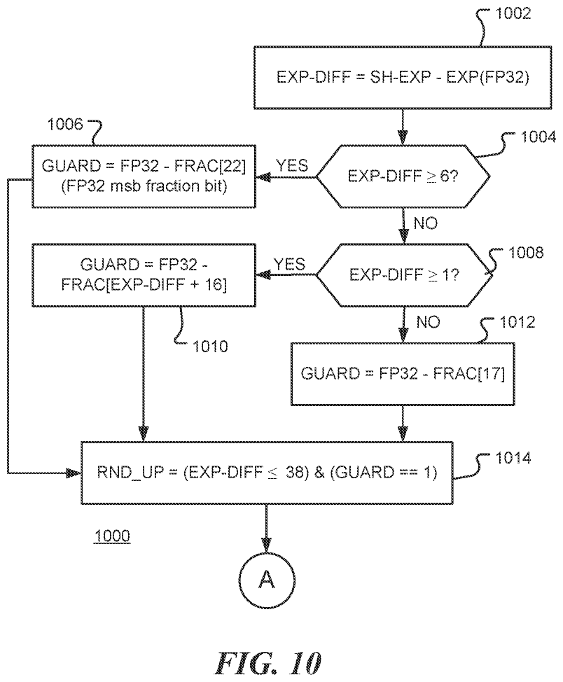

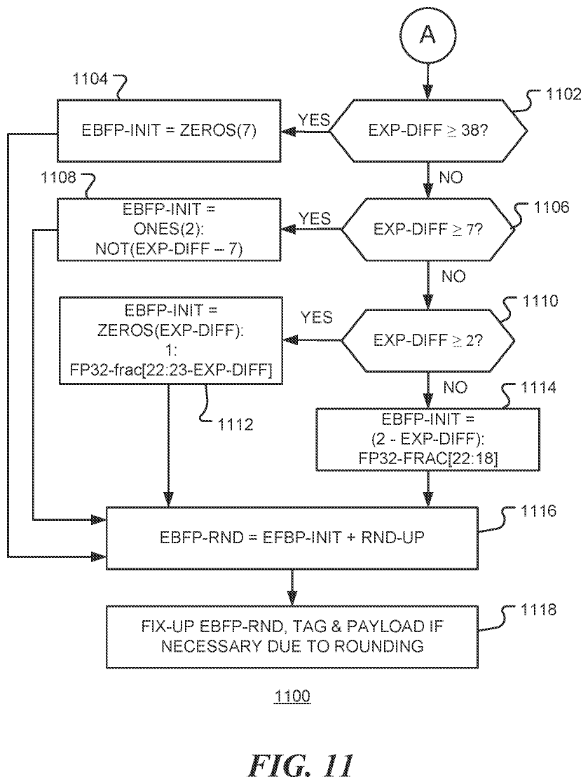

A method for rounding FP32 to EBFP8-r2 is described in FIGS. 10 and 11, described below, as an example. It will be apparent to those of skill in the art that methods for other formats can be readily derived from this one.

FIG. 10 is a flow chart of a method 1000 for rounding when converting from a 32-bit floating point number (FP32) to an 8-bit EBFP8r2 number with 8-bits. At block 1002, an exponent difference is determined. When the exponent difference is greater than or equal to 6, as depicted by the positive branch from decision block 1004, there is no fraction bit in the EBFP and a guard bit is set, at block 1006, to FP32-frac[22], i.e., the most significant fraction bits of FP32. Otherwise, flow continues to decision block 1008. When the exponent difference is greater than or equal to 2, as depicted by the positive branch from decision block 1008, the guard bit is set, at block 1010, to FP32-frac[exp-diff+16]. Otherwise, flow continues to block 1012 and the guard bit is set to FP32-frac[17]. At block 1014, a round-up bit (RND-UP) is set to “one” is exp-diff≤38 and the guard bit equals 1 and to “zero”. Flow than continues to point “A” in FIG. 11.

FIG. 11 is a flow chart of a method 1100 for converting from a 32-bit floating point number (FP32) to an 8-bit EBFP8r2 number with 8-bits. Once a rounded significand has been determined, as described above with reference to FIG. 10, flow continues at point “A”. When the exponent difference is greater than or equal to 38, as depicted by the positive branch from decision block 1102, an initial EBFP code is set to 7 zero bits at block 1104. Otherwise, when the exponent difference is greater than or equal to 7, as depicted by the positive branch from decision block 1106, the first 2 bits of the initial EBFP code are set to “one” and the remainder are set to the negation of (exponent difference—7) at block 1108. Otherwise, when the exponent difference is greater than or equal to 2, as depicted by the positive branch from decision block 1110, the initial EBFP code is set, at block 1112, to:

{Zeros(exp−diff): “1”: FP32-frac [22:23−exp−diff]}

Finally, when the exponent difference is less than 2, the initial EBFP code is set at block 1114 to:

{(2−exp−diff): FP32-frac[22:18]}.

At block 1116, the rounded EBFP code is set as the initial code plus the round-up bit.

When the exponent difference is 38, 7 or 0, and the round-up bit is one, the rounding operation may cause the tag value to change. In this case, the rounded EBFP, tag, and payload may be adjusted, as depicted by block 1118.

TABLE 19 shows conversions from FP32 into EBFP8-r2 for some example numbers, in accordance with various embodiments of the disclosure. The shared exponent is sh-exp=+4. For cases where the tag value changes when rounding is applied, the tag values are shown in bold font.

TABLE 19

| | FP32 input | | | | | | | | EBFP-rnd |
|---|---|---|---|---|---|---|---|---|---|
| FP32 input | (hex) | exp-diff | sign | tag-init | EBFP-init | L, G | rnd_up | EBFP-rnd | (FP32) |
| +1.fc0002p+4 | 0x41fe0001 | 0 | 0 | 10 | (1.)11111 | 1, 1 | 1 | 0 11 00000 | +1.00p+5 |
| −1.f80000p+4 | 0xc1fc0000 | 0 | 1 | 10 | (1.)11111 | 1, 0 | 0 | 1 10 11111 | −1.f8p+4 |
| +1.fc0002p+3 | 0x417e0001 | 1 | 0 | 01 | (1.)11111 | 1, 1 | 1 | 0 10 00000 | +1.00p+4 |
| +1.f7fffep+2 | 0x40fbffff | 2 | 0 | 00 | (0.)11111 | 1, 0 | 0 | 0 00 11111 | +1.f0p+2 |
| +1.c00002p+1 | 0x40600001 | 3 | 0 | 00 | 01110 | 0, 1 | 1 | 0 00 01111 | +1.e0p+1 |
| +1.000000p−1 | 0x3f000000 | 5 | 0 | 00 | 00010 | 0, 0 | 0 | 0 00 00010 | +1.00p−1 |
| +1.800002p−2 | 0x3ec00001 | 6 | 0 | 00 | 00001 | (x,)1 | 1 | 0 00 00010 | +1.00p−1 |
| +1.000000p−2 | 0x3e800000 | 6 | 0 | 00 | 00001 | (x,)0 | 0 | 0 00 00001 | +1.00p−2 |
| +1.800002p−3 | 0x3e400001 | 7 | 0 | 11 | 11111 | (x,)1 | 1 | 0 00 00001 | +1.00p−2 |
| +1.000000p−3 | 0x3e000000 | 7 | 0 | 11 | 11111 | (x,)0 | 0 | 0 11 11111 | +1.00p−3 |
| −1.7ffffep−4 | 0xbdbfffff | 8 | 1 | 11 | 11110 | (x,)0 | 0 | 1 11 11110 | −1.00p−4 |
| +1.000000p−4 | 0x3d800000 | 8 | 0 | 11 | 11110 | (x,)0 | 0 | 0 11 11110 | +1.00p−4 |
| +1.800002p−33 | 0x2f400001 | 37 | 0 | 11 | 00001 | (x,)1 | 1 | 0 11 00010 | +1.00p−32 |
| −1.7ffffep−33 | 0xaf3fffff | 37 | 1 | 11 | 00001 | (x,)0 | 0 | 1 11 00001 | −1.00p−33 |
| +1.800002p−34 | 0x2ec00001 | 38 | 0 | 00 | 00000 | (x,)1 | 1 | 0 11 00001 | +1.00p−33 |
| −1.7ffffep−34 | 0xaebfffff | 38 | 1 | 00 | 00000 | (x,)0 | 0 | 0 00 00000 | +0.0 |
| +1.800002p−35 | 0x2e400001 | 39 | 0 | 00 | 00000 | (x,)1 | 1 | 0 00 00000 | +0.0 |
| −1.7ffffep−35 | 0xae3fffff | 39 | 1 | 00 | 00000 | (x,)0 | 0 | 0 00 00000 | +0.0 |
| +1.000000p−35 | 0x2e000000 | 39 | 0 | 00 | 00000 | (x,)0 | 0 | 0 00 00000 | +0.0 |

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or that is has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed. Similarly, dedicated processors and/or dedicated hard wired logic may be used to construct alternative equivalent embodiments of the present disclosure.

Dedicated or reconfigurable hardware components used to implement the disclosed mechanisms may be described, for example, by instructions of a hardware description language (HDL), such as VHDL, Verilog or RTL (Register Transfer Language), or by a netlist of components and connectivity. The instructions may be at a functional level or a logical level or a combination thereof. The instructions or netlist may be input to an automated design or fabrication process (sometimes referred to as high-level synthesis) that interprets the instructions and creates digital hardware that implements the described functionality or logic.

The HDL instructions or the netlist may be stored on non-transitory computer readable medium such as Electrically Erasable Programmable Read Only Memory (EEPROM); non-volatile memory (NVM); mass storage such as a hard disc drive, floppy disc drive, optical disc drive; optical storage elements, magnetic storage elements, magneto-optical storage elements, flash memory, core memory and/or other equivalent storage technologies without departing from the present disclosure. Such alternative storage devices should be considered equivalents.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations carried out can often be varied, additional operations can be added or operations can be deleted without departing from the present disclosure. Such variations are contemplated and considered equivalent.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A digital processor comprising:
a subtraction unit configured to determine an exponent difference between a base exponent and an exponent of an input value, the input value having a sign, an exponent and a significand;
a tag unit configured to produce a tag value based, at least in part, on the exponent difference;
a positional encoder configured to produce a first payload based on the significand of the input value and the exponent difference;
an exponent unit configured to produce a second payload from the exponent difference; and
output storage configured to store, as an output value, the tag value, a sign bit indicating the sign of input value and a payload equal to:
the first payload when the exponent difference is less than a first threshold, and
the second payload when the exponent difference is not less than the first threshold.

2. The digital processor of claim 1, where the positional encoder is configured to:
encode the exponent difference to produce an encoded exponent difference;
round a fractional part of the significand of the input value, based on the encoded exponent difference, to produce a rounded fractional part; and
combine the rounded fractional part and the encoded exponent difference to produce the first payload.

3. The digital processor of claim 2, where the positional encoder is further configured to signal the tag unit and set the first payload to zero when rounding of the fractional part overflows.

4. The digital processor of claim 2, where the encoded exponent difference comprises zero or more bits set to a first value, a bit set to a value other than the first value, and zero or more additional bits, and where the number of bits set to the first value, the exponent, and the values of any additional bits are determined based on the exponent difference.

5. The digital processor of claim 1, where the positional encoder is configured to right shift the significand of the input value by the exponent difference to produce the first payload.

6. The digital processor of claim 5, where the positional encoder is configured to round the significand and, when the rounded significand overflows:
update the tag value; and
updating the first payload.

7. The digital processor of claim 1, where the exponent unit is configured to:
subtract a bias value from the exponent difference to produce the second payload, when the exponent difference is less than a second threshold value; and
set the second payload to a designated underflow value, when the exponent difference is not less than the second threshold value.

8. The digital processor of claim 1, where the tag unit is configured to produce a single-bit tag value indicating whether the exponent difference is less than the first threshold or not less than the first threshold.

9. The digital processor of claim 1, where the tag unit is configured to produce a tag value having two or more bits and indicating a format of the payload and a shift value.

10. The digital processor of claim 9, where the positional encoder is configured to produce the first payload as one of:
a rounded and shifted fractional part of the significand;
a combination of a rounded and shifted fractional part of the significand and an encoded exponent difference; and
zero.

11. The digital processor of claim 1, configured to determine the base exponent as a maximum exponent of a block of input values.

12. A computer-implemented method comprising:
determining an exponent difference between a base exponent and an exponent of an input value, the input value having a sign, an exponent and a significand;
setting, based on the exponent difference, one or more tag bits of an output value having a sign bit, the one or more tag bits, and a payload;
when the exponent difference is less than a first threshold, generating the payload of the output value based on the significand of the input value and the exponent difference;
when the exponent difference is not less than the first threshold, generating the payload of the output value by encoding the exponent difference to the payload;
setting the sign bit of the output value based on the sign bit of input value; and
storing the output value.

13. The computer-implemented method of claim 12, further comprising determining the base exponent as a maximum exponent of a block of input values.

14. The computer-implemented method of claim 12, where encoding the significand of the input value comprises:
rounding a fractional part of the significand of the input value based on the exponent difference to produce a rounded fractional part;
encoding the exponent difference to produce an encoded exponent difference; and
combining the rounded fractional part and the encoded exponent difference to produce the payload.

15. The computer-implemented method of claim 14, where encoding the significand of the input value comprises setting the payload to zero and resetting one or more tag bits when rounding of the fractional part overflows.

16. The computer-implemented method of claim 12, where encoding the exponent difference to the payload of the output value comprises:
subtracting a bias value from the exponent difference to produce the payload of the output value, when the exponent difference is less than a second threshold value; and
set the payload of the output value to a designated underflow value, when the exponent difference is not less than the second threshold value.

17. The computer-implemented method of claim 12, where setting one or more tag bits of the output value based on the exponent difference comprises setting a single-bit tag value to indicate whether the exponent difference is less than the first threshold or not less than the first threshold.

18. The computer-implemented method of claim 12, where setting one or more tag bits of the output value based on the exponent difference comprises setting two or more tag bits to indicate a format of the payload of the output value and a shift value.

19. The computer-implemented method of claim 18, where encoding the significand of the input value to the payload of the output value comprises producing a payload selected from:
a rounded fractional part of the significand;
a combination of a rounded fractional part of the significand and an encoded exponent difference; and
zero.

20. A computer-implemented method comprising:
determining an exponent difference between a base exponent and an exponent of an input value, the input value having a sign, an exponent and a significand;
when the exponent difference is less than a first threshold:
generating a tag value and a payload of an output value based on the significand of the input value and the exponent difference;
when the exponent difference is not less than the first threshold:
setting the tag value of the output value to a designated value, and
generating the payload of the output value by encoding the exponent difference to the payload;
setting a sign of the output value to the sign of input value; and
storing the output value.
